(19) United States
(12) Patent Application Publication
(10) Pub. No.: US 2024/0095837 A1
(43) Pub. Date: Mar. 21, 2024

(54) SYSTEMS AND METHODS FOR DETERMINING ADDITIONAL DRIVERS IN A HOUSEHOLD

(71) Applicant: BlueOwl, LLC, San Francisco, CA (US)

(72) Inventors: Kenneth Jason Sanchez, San Francisco, CA (US); Blake Konrardy, Chicago, IL (US)

(21) Appl. No.: 17/673,599

(22) Filed: Feb. 16, 2022

Related U.S. Application Data
(60) Provisional application No. 63/153,735, filed on Feb. 25, 2021.

(51) Int. Cl. G06Q 40/08; B60W 40/09

(52) U.S. Cl. CPC G06Q 40/08; B60W 40/09; G06N 7/005

(57) ABSTRACT

Method and system for determining which household members should be included as additional drivers. For example, the method includes receiving individual and household data associated with a first user, determining first characteristics of the first user, retrieving individual and household data associated with second users possessing second characteristics, selecting one or more of the second users to be included as third users based on comparing the second characteristics of the second users to the first characteristics of the first user, retrieving insurance data of the third users, using a machine learning model to determine probabilities that members of the first user's household should be included as additional drivers based on the insurance data of the third users, generating an insurance quote on a vehicle associated with the first user based on the probabilities, and displaying the insurance quote.

### CROSS-REFERENCE TO RELATED APPLICATIONS

This application claims priority to U.S. Provisional Patent Application No. 63/153,735, filed Feb. 25, 2021, incorporated by reference herein for all purposes.

### FIELD OF THE DISCLOSURE

Some embodiments of the present disclosure are directed to determining additional drivers associated with a user's household. More particularly, certain embodiments of the present disclosure provide methods and systems for determining which members of the user's household should be included as additional drivers for a vehicle of the user. Merely by way of example, the present disclosure has been applied to estimating insurance premiums for the vehicle based on the determined additional drivers. But it would be recognized that the present disclosure has much broader range of applicability.

### BACKGROUND OF THE DISCLOSURE

When obtaining an insurance policy for a vehicle, an insured may not want to include additional individuals on the insurance policy because any added driver would lead to higher premiums. The insured is also aware that if another individual using the vehicle is involved in an accident, the insurance policy will normally cover that individual. Accordingly, there is a need to automatically determine additional drivers that may be using the vehicle so that insurance premiums can be accurately estimated.

### BRIEF SUMMARY OF THE DISCLOSURE

Some embodiments of the present disclosure are directed to determining additional drivers associated with a user's household. More particularly, certain embodiments of the present disclosure provide methods and systems for determining which members of the user's household should be included as additional drivers for a vehicle of the user. Merely by way of example, the present disclosure has been applied to estimating insurance premiums for the vehicle based on the determined additional drivers. But it would be recognized that the present disclosure has much broader range of applicability.

According to certain embodiments, a method for determining which members of a user's household should be included as additional drivers includes receiving individual and household data associated with a first user and determining one or more first characteristics of the first user based at least in part upon the individual and household data. Also, the method includes retrieving individual and household data associated with multiple second users from a database, where each second user of the multiple second users possesses one or more second characteristics. For each second user of the multiple second users, the method includes analyzing the one or more second characteristics, determining one or more differences between the one or more second characteristics and the one or more first characteristics to determine whether the one or more differences satisfy one or more predetermined conditions, and if the one or more differences are determined to satisfy the one or more predetermined conditions, selecting each second user of the multiple second users as a third user to be included in one or more third users. Additionally, the method includes retrieving insurance data of the one or more third users from the database. Further, the method includes using a machine learning model to determine one or more probabilities that one or more members of the first user's household should be included as one or more additional drivers based at least in part upon the insurance data of the one or more third users. Moreover, the method includes generating an insurance quote on a vehicle associated with the first user based at least in part upon the one or more probabilities that the one or more members of the first user's household should be included as the one or more additional drivers, and displaying the insurance quote on the vehicle associated with the first user.

According to some embodiments, a computing device for determining which members of a user's household should be included as additional drivers includes one or more processors and a memory storing instructions for execution by the one or more processors. The instructions, when executed, cause the one or more processors to receive individual and household data associated with a first user and determine one or more first characteristics of the first user based at least in part upon the individual and household data. Also, the instructions, when executed, cause the one or more processors to retrieve individual and household data associated with multiple second users from a database, where each second user of the multiple second users possesses one or more second characteristics. For each second user of the multiple second users, the instructions, when executed, cause the one or more processors to analyze the one or more second characteristics, determine one or more differences between the one or more second characteristics and the one or more first characteristics to determine whether the one or more differences satisfy one or more predetermined conditions, and if the one or more differences are determined to satisfy the one or more predetermined conditions, select each second user of the multiple second users as a third user to be included in one or more third users. Additionally, the instructions, when executed, cause the one or more processors to retrieve insurance data of the one or more third users from the database. Further, the instructions, when executed, cause the one or more processors to use a machine learning model to determine one or more probabilities that one or more members of the first user's household should be included as one or more additional drivers based at least in part upon the insurance data of the one or more third users. Moreover, the instructions, when executed, cause the one or more processors to generate an insurance quote on a vehicle associated with the first user based at least in part upon the one or more probabilities that the one or more members of the first user's household should be included as the one or more additional drivers, and display the insurance quote on the vehicle associated with the first user.

According to certain embodiments, a non-transitory computer-readable medium storing instructions for determining which members of a user's household should be included as additional drivers. The instructions are executed by one or more processors of a computing device. The non-transitory computer-readable medium includes instructions to receive individual and household data associated with a first user and determine one or more first characteristics of the first user based at least in part upon the individual and household data. Also, the non-transitory computer-readable medium includes instructions to retrieve individual and household data associated with multiple second users from a database, where each second user of the multiple second users possesses one or more second characteristics. For each second user of the multiple second users, the non-transitory computer-readable medium includes instructions to analyze the one or more second characteristics, determine one or more differences between the one or more second characteristics and the one or more first characteristics to determine whether the one or more differences satisfy one or more predetermined conditions, if the one or more differences are determined to satisfy the one or more predetermined conditions, select each second user of the multiple second users as a third user to be included in one or more third users. Additionally, the non-transitory computer-readable medium includes instructions to retrieve insurance data of the one or more third users from the database. Further, the non-transitory computer-readable medium includes instructions to use a machine learning model to determine one or more probabilities that one or more members of the first user's household should be included as one or more additional drivers based at least in part upon the insurance data of the one or more third users. Moreover, the non-transitory computer-readable medium includes instructions to generate an insurance quote on a vehicle associated with the first user based at least in part upon the one or more probabilities that the one or more members of the first user's household should be included as the one or more additional drivers, and display the insurance quote on the vehicle associated with the first user.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1A, FIG. 1B, and FIG. 1C show a simplified method for determining additional drivers in a household according to certain embodiments of the present disclosure.

FIG. 2 is a simplified method for training an artificial neural network for determining additional drivers in a household according to certain embodiments of the present disclosure.

FIG. 3 shows a simplified system for determining additional drivers in a household according to certain embodiments of the present disclosure.

FIG. 4 shows a simplified computing device for determining additional drivers in a household according to certain embodiments of the present disclosure.

### DETAILED DESCRIPTION OF THE DISCLOSURE

Some embodiments of the present disclosure are directed to determining additional drivers associated with a user's household. More particularly, certain embodiments of the present disclosure provide methods and systems for determining which members of the user's household should be included as additional drivers for a vehicle of the user. Merely by way of example, the present disclosure has been applied to estimating insurance premiums for the vehicle based on the determined additional drivers. But it would be recognized that the present disclosure has much broader range of applicability.

### I. One or More Methods for Determining Additional Drivers in A Household According to Certain Embodiments

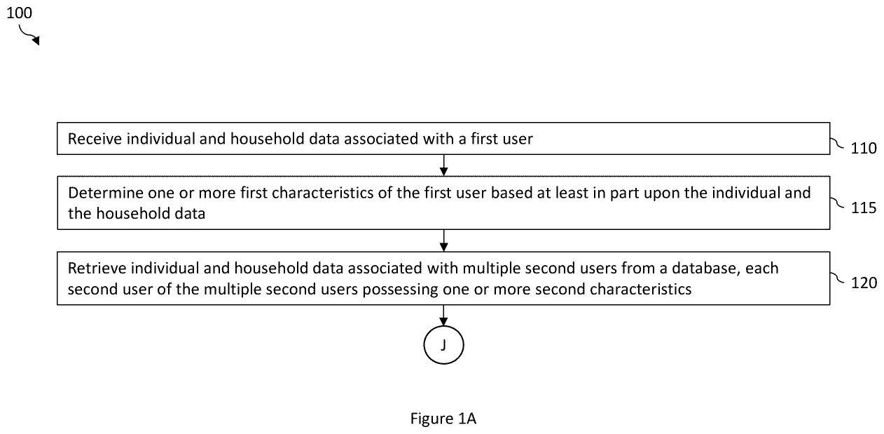

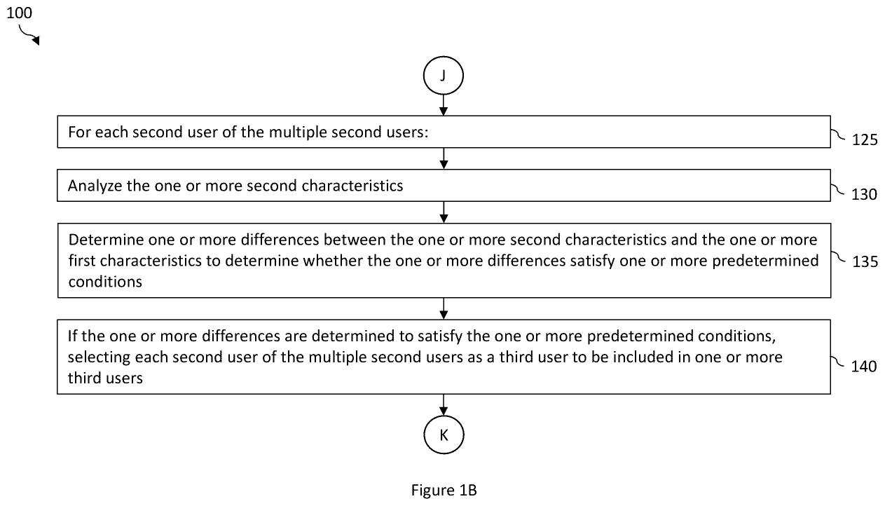

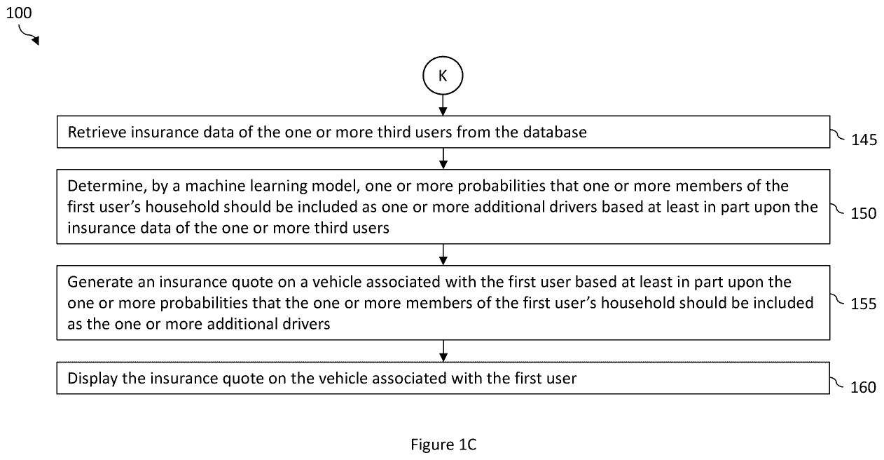

FIG. 1A, FIG. 1B, and FIG. 1C show a simplified method for determining additional drivers in a household according to certain embodiments of the present disclosure. The figures are merely examples, which should not unduly limit the scope of the claims. One of ordinary skill in the art would recognize many variations, alternatives, and modifications. The method 100 includes process 110 for receiving data of a first user, process 115 for determining first characteristics of the first user, process 120 for determining second characteristics of second users, processes 125-140 for analyzing the second users including process 130 for analyzing the second characteristics, process 135 for comparing the first characteristics and the second characteristics, and process 140 for selecting one or more of the second users as third users, process 145 for retrieving insurance data of the third users, process 150 for using a machine learning model to determine which members of the first user's household should be included as additional drivers, process 155 for generating an insurance quote, and process 160 for displaying the insurance quote. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 110, individual and household data associated with the first user are received according to certain embodiments. In some embodiments, the individual and household data include personal and vehicle information associated with the first user, such as age, gender, marital status, occupation, city/state of residence, hobbies, vehicle type/model/year, driver license status, etc. In certain embodiments, the individual and household data include personal and vehicle information associated with one or more members of the first user's household, such as a number of individuals living in the household, age and gender of those individuals, occupations of those individuals, a number of vehicles registered in the household, etc. In some embodiments, the individual and household data are received in response to a request from the first user. For example, the first user initiates an insurance quote request and provides the individual and household data.

At the process 115, one or more first characteristics of the first user are determined based at least in part upon the individual and household data according to certain embodiments. For example, the one or more first characteristics may indicate that the first user is a male living with another individual in a household with one vehicle. As an example, the one or more first characteristic may indicate that the first user is a male who works as at a hospital and has four other individuals living in a household with two vehicles. For example, the one or more first characteristics may indicate that the first user is a female who lives in an urban area and has two other individuals living in a household with one vehicle.

At the process 120, individual and household data associated with multiple second users are retrieved from a database according to certain embodiments. In various embodiments, each of the multiple second users possesses one or more second characteristics. In some embodiments, the individual and household data associated with the multiple second users include personal and vehicle information of each of the multiple second users and/or personal and vehicle information of various household members of each of the multiple second users.

In certain embodiments, the one or more second characteristics are determined based at least in part upon the individual and household data associated with the multiple second users. For example, the one or more second characteristics may indicate that a second user of the multiple second users is a female who has at least one other individual living in a household with one vehicle. As an example, the one or more second characteristics may indicate that another second user of the multiple second users is a male who has four other individuals living in a household with two vehicles.

In some embodiments, the database is an insurance policy database maintained by an insurance provider associated with the first user. For example, one or more vehicles of the first user are insured with the insurance provider. In certain embodiments, the multiple second users include any or all customers (e.g., current customers, former customers, etc.) who are/were insured or have/had insurance with the insurance provider. In some embodiments, the database includes any number of public databases (e.g., vital records database, vehicle registration database, etc.).

Starting from the process 125 to the process 140, each of the multiple second users is analyzed according to certain embodiments. At the process 130, the one or more second characteristics of each second user are analyzed according to certain embodiments. In various embodiments, analyzing the one or more second characteristics involves comparing the one or more second characteristics of each second user with the one or more first characteristics of the first user.

At the process 135, one or more differences between the one or more second characteristics of each second user and the one or more first characteristics of the first user are determined according to certain embodiments. In some embodiments, the one or more differences indicate how similar or dissimilar each second user is to the first user. For example, a similarity would show that the first user and a second user have the same work occupation with one vehicle in each household. As an example, a dissimilarity would show that the first user and a second user live in different cities with each household having a different number of vehicles. In certain embodiments, the one or more differences indicate how similar or dissimilar each member of each second user's household is to each member of the first user's household. For example, a similarity would show that each member of the first user's household and each member of a second user's household are of comparable age and one vehicle is present in each household. As an example, a dissimilarity would show that at least one member of the first user's household is of a different age than a member of the second user's household and different numbers of vehicles are present in each household.

In various embodiments, whether the one or more differences satisfy one or more predetermined conditions are determined. As an example, the one or more predetermined conditions may be based on the number of members and vehicles in a household. For example, the first user's household includes four other members and two vehicles. As an example, if a second user's household also includes at least four other members and at least two vehicles, then the one or more differences resulting from the comparison of the one or more second characteristics of the second user and the one or more first characteristic of the first user would satisfy the one or more predetermined conditions. For example, the one or more predetermined conditions may be based on the age of members and the number of vehicles in a household. As an example, the first user's household includes two other members of a certain age (e.g., 18-20 years old) and one vehicle. For example, if a second user's household also includes at least two other members of a similar age and one vehicle, then the one or more differences resulting from the comparison of the one or more second characteristics of the second user and the one or more first characteristic of the first user would satisfy the one or more predetermined conditions.

At the process 140, if the one or more differences are determined to satisfy the one or more predetermined conditions, each second user of the multiple second users is selected as a third user to be included in one or more third users according to certain embodiments. For example, the one or more third users include any and all second users whose one or more differences resulting from the comparison with the first user are determined to satisfy the one or more predetermined conditions.

At the process 145, insurance data of the one or more third users are retrieved from the database according to certain embodiments. In various embodiments, the insurance data include vehicle insurance policy information for each of the one or more third users (e.g., how many vehicles are covered, types of vehicles covered, amount of coverage, how many drivers are covered, identities of those drivers covered, claims submitted by insured individuals, claims submitted by uninsured individuals, etc.). In some embodiments, the insurance data are retrieved from the insurance policy database maintained by the insurance provider associated with the first user.

At the process 150, a machine learning model is used to determine one or more probabilities that the one or more members of the first user's household should be included as one or more additional drivers based at least in part upon the insurance data of the one or more third users according to certain embodiments. In some embodiments, the individual and household data and the insurance data of the one or more third users are processed to generate the one or more probabilities. For example, the individual and household data and the insurance data are processed using any suitable machine learning model (e.g., decision tree, random forest, support vector machine, logistic regression, etc.).

In certain embodiments, the individual and household data and the insurance data are provided to an artificial neural network to generate the one or more probabilities. In some embodiments, the artificial neural network is trained based at least in part upon the individual and household data and the insurance data of the one or more third users. In certain embodiments, the trained artificial neural network possesses existing knowledge of which features in the individual and household data and the insurance data are useful in determining the one or more additional drivers. For example, determining the one or more additional drivers involves that the trained artificial neural network model analyzes the individual and household data and the insurance data based upon the existing knowledge. As an example, analyzing the individual and household data and the insurance data includes various tasks such as performing feature extractions, applying pattern recognition, and/or other suitable tasks.

In some embodiments, the artificial neural network is used to predict which members of the first user's household should be included as the one or more additional drivers. In certain embodiments, the artificial neural network is used to predict how many members of the first user's household should be included as the one or more additional drivers. In some embodiments, the artificial neural network is used to predict which members of the first user's household should be excluded as the one or more additional drivers.

In certain examples, only the first user is listed as a driver in the first user's household. For example, using the machine learning model, a probability of 80% was determined that another individual who also resides in the first user's household is an additional driver. In some examples, the first user indicated the number of additional drivers in the household is three. For example, using the machine learning model, a probability of 10% was determined for the number of additional drivers in the household to be two, a probability of 25% was determined for the number of additional drivers in the household to be three, and a probability of 50% was determined for the number of additional drivers in the household to be four. As an example, based upon the probabilities, it is highly likely that the first user has underreported the number of additional drivers in the household because there is a 50% probability that the number of additional drivers in the household is more than three.

At the process 155, the insurance quote on a vehicle associated with the first user is generated based at least in part upon the one or more probabilities that the one or more members of the first user's household should be included as the one or more additional drivers according to certain embodiments. In various embodiments, the insurance quote considers the probability of having additional drivers for the vehicle. In some embodiments, respective rating factors are calculated for each member of the one or more members of the first user's household that should be included as the one or more additional drivers. In certain embodiments, generating the insurance quote is based at least in part upon the respective rating factors. For example, the first user indicated individuals A and B residing in the first user's household as drivers of the vehicle. As an example, an individual C who also resides in the first user's household was determined to have a probability of 50% of being included as an additional driver. For example, the rating factor for individual C can be calculated and modified by the 50% probability. As an example, the rating factor is included in the insurance quote to compensate for insurance coverage on individual C who is likely to be operating the vehicle. In some embodiments, the insurance quote on the vehicle is generated in response to the insurance quote request initiated by the first user.

At the process 160, the insurance quote on the vehicle associated with the first user is displayed according to certain embodiments. For example, the insurance quote is displayed on a computing device (e.g., mobile device) of the first user for viewing by the first user.

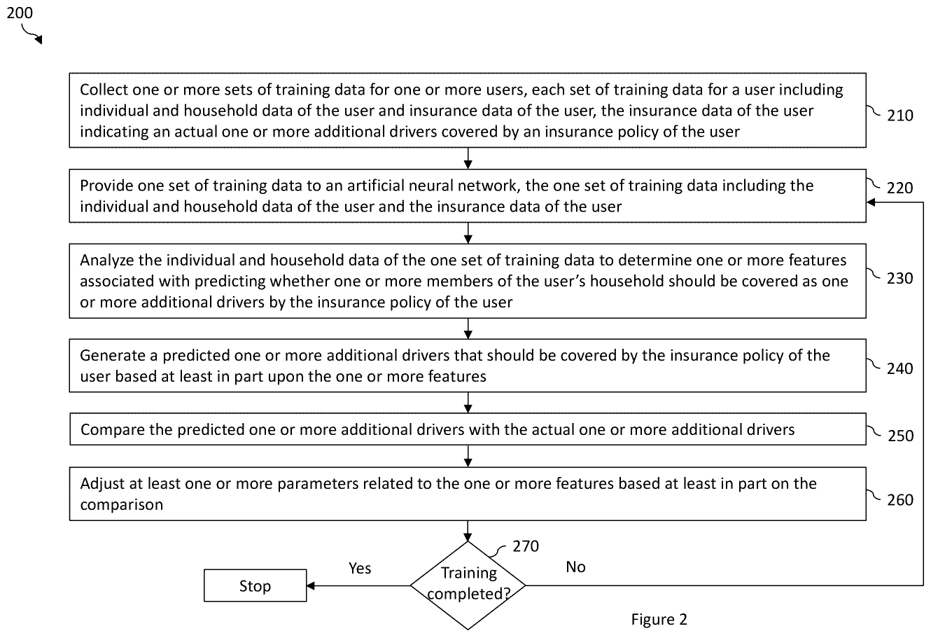

FIG. 2 is a simplified method for training an artificial neural network for determining additional drivers in a household according to certain embodiments of the present disclosure. This diagram is merely an example, which should not unduly limit the scope of the claims. One of ordinary skill in the art would recognize many variations, alternatives, and modifications. The method 200 includes process 210 for collecting sets of training data, process 220 for providing one set of training data to an artificial neural network for training, process 230 for analyzing the one set of training data, process 240 for generating predicted additional drivers, process 250 for comparing the predicted additional drivers with actual additional drivers, process 260 for adjusting parameters related to the artificial neural network, and process 270 for determining whether training of the artificial neural network has been completed. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 210, one or more sets of training data for one or more users are collected according to certain embodiments. For example, each set of training data for a user includes individual and household data of the user and insurance data of the user. In some embodiments, the individual and household data include personal and vehicle information associated with the user (e.g., age, occupation, vehicle type/model/year, etc.). In certain embodiments, the individual and household data include personal and vehicle information associated with one or more members of the user's household. In some embodiments, the insurance data include vehicle insurance policy information for the user. For example, the insurance data indicate an actual one or more additional drivers covered by an insurance policy of the user. In various embodiments, the individual and household data and the insurance data are retrieved from a database (e.g., an insurance policy database of an insurance provider associated with the user).

At the process 220, one set of training data in the one or more sets of training data is provided to the artificial neural network to train the artificial neural network according to certain embodiments. For example, the artificial neural network is a convolutional neural network, a recurrent neural network, a modular neural network, or any other suitable type of neural network. In various embodiments, the one set of training data include the individual and household data and the insurance data.

At the process 230, the individual and household data of the one set of training data are analyzed by the artificial neural network to determine one or more features associated with predicting whether the one or more members of the user's household should be covered as one or more additional drivers by the insurance policy of the user according to certain embodiments. In some embodiments, the one or more features are associated with predicting which members of the user's household should be included as the one or more additional drivers. In certain embodiments, the one or more features are associated with predicting how many members of the user's household should be included as the one or more additional drivers. In some embodiments, the one or more features are associated with predicting one or more probabilities for the members of the user's household to be included as the one or more additional drivers. In certain embodiments, the one or more features are associated with predicting which members of the user's household should be excluded as the one or more additional drivers.

At the process 240, a predicted one or more additional drivers are generated by the artificial neural network based at least in part upon the one or more features according to certain embodiments. For example, in generating the predicted one or more additional drivers, one or more parameters related to the one or more features are calculated by the artificial neural network (e.g., weight values associated with various layers of connections in the artificial neural network).

At the process 250, the predicted one or more additional drivers are compared with the actual one or more additional drivers covered by the insurance policy of the user to determine an accuracy of the predicted one or more additional drivers according to certain embodiments. In some embodiments, the accuracy is determined by using a loss function or a cost function for the one set of training data.

At the process 260, based at least in part upon the comparison, the one or more parameters related to the one or more features are adjusted by the artificial neural network according to certain embodiments. For example, the one or more parameters are adjusted in order to reduce (e.g., minimize) the loss function or the cost function.

At the process 270, a determination is made on whether the training has been completed according to certain embodiments. For example, training for the one set of training data is completed when the loss function or the cost function for the one set of training data is sufficiently reduced (e.g., minimized). As an example, training for the artificial neural network is completed when training for each of the one or more sets of training data is accomplished.

In some embodiments, if the process 270 determines that training of the artificial neural network is not yet completed, then the method 200 returns to the process 220 in an iterative manner until training is deemed to be completed.

In certain embodiments, if the process 270 determines that training of the artificial neural network is completed, then the method 200 for training the artificial neural network stops. In some examples, the artificial neural network that has been trained by the method 200 is used as the machine learning model by the process 150 of the method 100. In certain examples, the trained artificial neural network possesses existing knowledge of which features are desirable or useful in terms of determining the one or more additional drivers.

### II. One or More Systems for Determining Additional Drivers in a Household According to Certain Embodiments

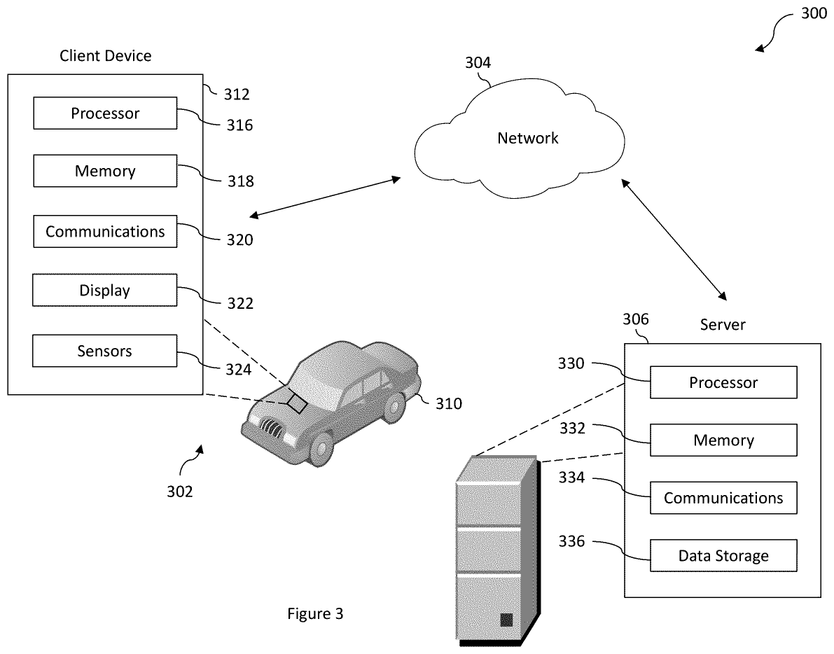

FIG. 3 shows a simplified system for determining additional drivers in a household according to certain embodiments of the present disclosure. This figure is merely an example, which should not unduly limit the scope of the claims. One of ordinary skill in the art would recognize many variations, alternatives, and modifications. The system 300 includes a vehicle system 302, a network 304, and a server 306. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the system 300 is used to implement the method 100 and/or the method 200. According to certain embodiments, the vehicle system 302 includes a vehicle 310 and a client device 312 associated with the vehicle 310. For example, the client device 312 is a mobile device (e.g., a smartphone) located in the vehicle 310. For example, the client device 312 includes a processor 316 (e.g., a central processing unit (CPU), a graphics processing unit (GPU)), a memory 318 (e.g., random-access memory (RAM), read-only memory (ROM), flash memory), a communications unit 320 (e.g., a network transceiver), a display unit 322 (e.g., a touchscreen), and one or more sensors 324 (e.g., an accelerometer, a gyroscope, a magnetometer, a barometer, a GPS sensor).

In some embodiments, the vehicle 310 is operated by a driver. In certain embodiments, multiple vehicles 310 exist in the system 300 which are operated by respective drivers. In various embodiments, during one or more vehicle trips, the one or more sensors 324 collect data associated with vehicle operation, such as acceleration, braking, location, etc. According to some embodiments, the data are collected continuously, at predetermined time intervals, and/or based on a triggering event (e.g., when each sensor has acquired a threshold amount of sensor measurements).

According to certain embodiments, the collected data are stored in the memory 318 before being transmitted to the server 306 using the communications unit 320 via the network 304 (e.g., via a local area network (LAN), a wide area network (WAN), the Internet). In some embodiments, the collected data are transmitted directly to the server 306 via the network 304. For example, the collected data are transmitted to the server 306 without being stored in the memory 318. In certain embodiments, the collected data are transmitted to the server 306 via a third party. For example, a data monitoring system stores any and all data collected by the one or more sensors 324 and transmits those data to the server 306 via the network 304 or a different network.

According to some embodiments, the server 306 includes a processor 330 (e.g., a microprocessor, a microcontroller), a memory 332, a communications unit 334 (e.g., a network transceiver), and a data storage 336 (e.g., one or more databases). In some embodiments, the server 306 is a single server, while in certain embodiments, the server 306 includes a plurality of servers with distributed processing. In FIG. 3, the data storage 336 is shown to be part of the server 306. In certain embodiments, the data storage 336 is a separate entity coupled to the server 306 via a network such as the network 304. In some embodiments, the server 306 includes various software applications stored in the memory 332 and executable by the processor 330. For example, these software applications include specific programs, routines, or scripts for performing functions associated with the method 100 and/or the method 200. As an example, the software applications include general-purpose software applications for data processing, network communication, database management, web server operation, and/or other functions typically performed by a server.

According to various embodiments, the server 306 receives, via the network 304, the data collected by the one or more sensors 324 using the communications unit 334 and stores the data in the data storage 336. For example, the server 306 then processes the data to perform one or more processes of the method 100 and/or one or more processes of the method 200.

According to certain embodiments, any related information determined or generated by the method 100 and/or the method 200 (e.g., first characteristics, second characteristics, insurance quote, etc.) are transmitted back to the client device 312, via the network 304, to be provided (e.g., displayed) to the user via the display unit 322.

In some embodiments, one or more processes of the method 100 and/or one or more processes of the method 200 are performed by the client device 312. For example, the processor 316 of the client device 312 processes the data collected by the one or more sensors 324 to perform one or more processes of the method 100 and/or one or more processes of the method 200.

### III. One or More Computing Devices for Determining Additional Drivers in a Household According to Certain Embodiments

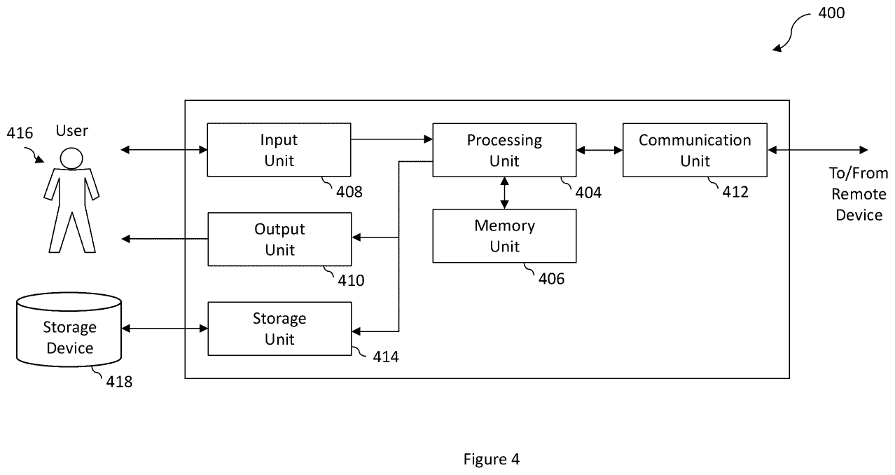

FIG. 4 shows a simplified computing device for determining additional drivers in a household according to certain embodiments of the present disclosure. This figure is merely an example, which should not unduly limit the scope of the claims. One of ordinary skill in the art would recognize many variations, alternatives, and modifications. The computing device 400 includes a processing unit 404, a memory unit 406, an input unit 408, an output unit 410, a communication unit 412, and a storage unit 414. In various embodiments, the computing device 400 is configured to be in communication with a user 416 and/or a storage device 418. In certain embodiments, the computing device 400 includes the client device 312 and/or the server 306 of FIG. 3. In some embodiments, the computing device 400 is configured to implement the method 100 of FIG. 1A, FIG. 1B, and/or FIG. 1C, and/or the method 200 of FIG. 2. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the processing unit 404 is configured for executing instructions, such as instructions to implement the method 100 of FIG. 1A, FIG. 1B, and/or FIG. 1C, and/or the method 200 of FIG. 2. In some embodiments, the executable instructions are stored in the memory unit 406. In certain embodiments, the processing unit 404 includes one or more processing units (e.g., in a multi-core configuration). In some embodiments, the processing unit 404 includes and/or is communicatively coupled to one or more modules for implementing the methods and systems described in the present disclosure. In certain embodiments, the processing unit 404 is configured to execute instructions within one or more operating systems. In some embodiments, upon initiation of a computer-implemented method, one or more instructions is executed during initialization. In certain embodiments, one or more operations is executed to perform one or more processes described herein. In some embodiments, an operation may be general or specific to a particular programming language (e.g., C, C++, Java, or other suitable programming languages, etc.).

In various embodiments, the memory unit 406 includes a device allowing information, such as executable instructions and/or other data to be stored and retrieved. In some embodiments, the memory unit 406 includes one or more computer readable media. In certain embodiments, the memory unit 406 includes computer readable instructions for providing a user interface, such as to the user 416, via the output unit 410. In some embodiments, a user interface includes a web browser and/or a client application. For example, a web browser enables the user 416 to interact with media and/or other information embedded on a web page and/or a website. In certain embodiments, the memory unit 406 includes computer readable instructions for receiving and processing an input via the input unit 408. In some embodiments, the memory unit 406 includes RAM such as dynamic RAM (DRAM) or static RAM (SRAM), ROM, erasable programmable read-only memory (EPROM), electrically erasable programmable read-only memory (EEPROM), and/or non-volatile RAM (NVRAM).

In various embodiments, the input unit 408 is configured to receive input (e.g., from the user 416). In some embodiments, the input unit 408 includes a keyboard, a pointing device, a mouse, a stylus, a touch sensitive panel (e.g., a touch pad or touch screen), a gyroscope, an accelerometer, a position sensor (e.g., GPS sensor), and/or an audio input device. In certain embodiments, the input unit 408 is configured to function as both an input unit and an output unit.

In various embodiments, the output unit 410 includes a media output unit configured to present information to the user 416. In some embodiments, the output unit 410 includes any component capable of conveying information to the user 416. In certain embodiments, the output unit 410 includes an output adapter such as a video adapter and/or an audio adapter. For example, the output unit 410 is operatively coupled to the processing unit 404 and/or a visual display device to present information to the user 416 (e.g., a liquid crystal display (LCD), a light emitting diode (LED) display, an organic light emitting diode (OLED) display, a cathode ray tube (CRT) display, a projected display, etc.). As an example, the output unit 410 is operatively coupled to the processing unit 404 and/or an audio display device to present information to the user 416 (e.g., a speaker arrangement or headphones).

In various embodiments, the communication unit 412 is configured to be communicatively coupled to a remote device. In some embodiments, the communication unit 412 includes a wired network adapter, a wireless network adapter, a wireless data transceiver for use with a mobile phone network (e.g., 3G, 4G, 5G, Bluetooth, near-field communication (NFC), etc.), and/or other mobile data networks. In certain embodiments, other types of short-range or long-range networks may be used. In some embodiments, the communication unit 412 is configured to provide email integration for communicating data between a server and one or more clients.

In various embodiments, the storage unit 414 is configured to enable communication between the computing device 400 and the storage device 418. In some embodiments, the storage unit 414 is a storage interface. For example, the storage interface is any component capable of providing the processing unit 404 with access to the storage device 418. In certain embodiments, the storage unit 414 includes an advanced technology attachment (ATA) adapter, a serial ATA (SATA) adapter, a small computer system interface (SCSI) adapter, a RAID controller, a SAN adapter, a network adapter, and/or any other component capable of providing the processing unit 404 with access to the storage device 418.

In various embodiments, the storage device 418 includes any computer-operated hardware suitable for storing and/or retrieving data. In certain embodiments, the storage device 418 is integrated in the computing device 400. In some embodiments, the storage device 418 includes a database such as a local database or a cloud database. In certain embodiments, the storage device 418 includes one or more hard disk drives. In some embodiments, the storage device 418 is external and is configured to be accessed by a plurality of server systems. In certain embodiments, the storage device 418 includes multiple storage units such as hard disks or solid state disks in a redundant array of inexpensive disks configuration. In some embodiments, the storage device 418 includes a storage area network and/or a network attached storage system.

### IV. Examples of Certain Embodiments of the Present Disclosure

According to certain embodiments, a method for determining which members of a user's household should be included as additional drivers includes receiving individual and household data associated with a first user and determining one or more first characteristics of the first user based at least in part upon the individual and household data. Also, the method includes retrieving individual and household data associated with multiple second users from a database, where each second user of the multiple second users possesses one or more second characteristics. For each second user of the multiple second users, the method includes analyzing the one or more second characteristics, determining one or more differences between the one or more second characteristics and the one or more first characteristics to determine whether the one or more differences satisfy one or more predetermined conditions, and if the one or more differences are determined to satisfy the one or more predetermined conditions, selecting each second user of the multiple second users as a third user to be included in one or more third users. Additionally, the method includes retrieving insurance data of the one or more third users from the database. Further, the method includes using a machine learning model to determine one or more probabilities that one or more members of the first user's household should be included as one or more additional drivers based at least in part upon the insurance data of the one or more third users. Moreover, the method includes generating an insurance quote on a vehicle associated with the first user based at least in part upon the one or more probabilities that the one or more members of the first user's household should be included as the one or more additional drivers, and displaying the insurance quote on the vehicle associated with the first user. For example, the method is implemented according to at least FIG. 1A, FIG. 1B, and/or FIG. 1C.

According to some embodiments, a computing device for determining which members of a user's household should be included as additional drivers includes one or more processors and a memory storing instructions for execution by the one or more processors. The instructions, when executed, cause the one or more processors to receive individual and household data associated with a first user and determine one or more first characteristics of the first user based at least in part upon the individual and household data. Also, the instructions, when executed, cause the one or more processors to retrieve individual and household data associated with multiple second users from a database, where each second user of the multiple second users possesses one or more second characteristics. For each second user of the multiple second users, the instructions, when executed, cause the one or more processors to analyze the one or more second characteristics, determine one or more differences between the one or more second characteristics and the one or more first characteristics to determine whether the one or more differences satisfy one or more predetermined conditions, and if the one or more differences are determined to satisfy the one or more predetermined conditions, select each second user of the multiple second users as a third user to be included in one or more third users. Additionally, the instructions, when executed, cause the one or more processors to retrieve insurance data of the one or more third users from the database. Further, the instructions, when executed, cause the one or more processors to use a machine learning model to determine one or more probabilities that one or more members of the first user's household should be included as one or more additional drivers based at least in part upon the insurance data of the one or more third users. Moreover, the instructions, when executed, cause the one or more processors to generate an insurance quote on a vehicle associated with the first user based at least in part upon the one or more probabilities that the one or more members of the first user's household should be included as the one or more additional drivers, and display the insurance quote on the vehicle associated with the first user. For example, the computing device is implemented according to at least FIG. 3 and/or FIG. 4.

According to certain embodiments, a non-transitory computer-readable medium storing instructions for determining which members of a user's household should be included as additional drivers. The instructions are executed by one or more processors of a computing device. The non-transitory computer-readable medium includes instructions to receive individual and household data associated with a first user and determine one or more first characteristics of the first user based at least in part upon the individual and household data. Also, the non-transitory computer-readable medium includes instructions to retrieve individual and household data associated with multiple second users from a database, where each second user of the multiple second users possesses one or more second characteristics. For each second user of the multiple second users, the non-transitory computer-readable medium includes instructions to analyze the one or more second characteristics, determine one or more differences between the one or more second characteristics and the one or more first characteristics to determine whether the one or more differences satisfy one or more predetermined conditions, if the one or more differences are determined to satisfy the one or more predetermined conditions, select each second user of the multiple second users as a third user to be included in one or more third users. Additionally, the non-transitory computer-readable medium includes instructions to retrieve insurance data of the one or more third users from the database. Further, the non-transitory computer-readable medium includes instructions to use a machine learning model to determine one or more probabilities that one or more members of the first user's household should be included as one or more additional drivers based at least in part upon the insurance data of the one or more third users. Moreover, the non-transitory computer-readable medium includes instructions to generate an insurance quote on a vehicle associated with the first user based at least in part upon the one or more probabilities that the one or more members of the first user's household should be included as the one or more additional drivers, and display the insurance quote on the vehicle associated with the first user. For example, the non-transitory computer-readable medium is implemented according to at least FIG. 1A, FIG. 1B, FIG. 1C, FIG. 3, and/or FIG. 4.

V. One or More Systems and Methods for Determining Additional Drivers Associated with a Household According to Some Embodiments

According to certain embodiments, a system and/or a method for determining whether all additional drivers are being disclosed includes receiving a request for an insurance quote on a vehicle associated with a user; receiving individual data related to the user; receiving an initial list of drivers that will operate the vehicle from the user; analyzing the individual data related to the user to determine an accuracy of the initial list of drivers; and/or adjusting an insurance premium based at least in part upon the accuracy of the initial list of drivers.

According to some embodiments, a system and/or a method for determining whether additional drivers are being disclosed includes receiving a request for an insurance quote on a vehicle associated with a user. For example, the user initiates the request and provides information about him/herself. In various embodiments, individual data related to the user are received. For example, the individual data include the user's characteristics (e.g., age, gender, occupation, city/state of residence, hobbies, etc.). As an example, the individual data include vehicle information associated with the vehicle (e.g., type/model/year). In some embodiments, an initial list of drivers that will operate the vehicle is received from the user. In certain embodiments, the individual data related to the user are analyzed to determine an accuracy of the initial list of drivers. For example, whether the user has disclosed all additional drivers that will operate the vehicle for purposes of insuring the vehicle.

According to certain embodiments, analyzing the individual data includes analyzing claims data from insurance policies of other users who share similar characteristics and/or vehicle information as the user. For example, the claims data are analyzed to determine which individuals submitted claims (e.g., submitted by insured drivers listed on the insurance policies of the other users or by someone else not listed on the insurance policies of the other users). As an example, whether the user has accurately disclosed additional drivers can be determined based at least in part upon analyzing the claims data. For example, a rating factor is calculated based at least in part upon whether the user has accurately disclosed the additional drivers. As an example, the rating factor can be used to adjust a premium associated with the insurance quote requested by the user.

In various embodiments, the user initially disclosed drivers A and B as additional drivers. In some embodiments, analysis of the claims data may indicate that another driver besides drivers A and B should have been disclosed. For example, if, after further inquiry, the user insists on only drivers A and B, then the rating factor may be calculated to be 30% because it is determined that the user is not being accurate in disclosing the additional drivers. As an example, the premium will be adjusted by adding the rating factor to compensate for insurance coverage on undisclosed drivers that may be operating the vehicle. In certain embodiments, analysis of the claims data may indicate that only drivers A and B need to be disclosed. For example, if, after further inquiry, the user confirms only drivers A and B, then no rating factor need to be calculated. As an example, the premium does not need to be adjusted since all drivers that will operate the vehicle will have been included in the insurance coverage.

In some embodiments, if the user is not being accurate in disclosing all additional drivers, additional feedback will be provided to the user. For example, the user will be required to sign an exclusion list that specifically states that whoever is not listed on the insurance quote/policy will be excluded from any insurance coverage.

According to certain embodiments, a system and/or a method for determining a probability of whether all additional drivers are being disclosed includes receiving a request for an insurance quote on a vehicle associated with a user; receiving individual data related to the user; receiving an initial list of drivers that will operate the vehicle from the user; analyzing the individual data related to the user to determine a probability of accuracy for the initial list of drivers; and/or adjusting an insurance premium based at least in part upon the probability of accuracy of the initial list of drivers.

According to some embodiments, a system and/or a method for determining a probability of whether additional drivers are being disclosed includes receiving a request for an insurance quote on a vehicle associated with a user. For example, the user initiates the request and provides information about him/herself. In various embodiments, individual data related to the user are received. For example, the individual data include the user's characteristics (e.g., age, gender, occupation, city/state of residence, hobbies, etc.). As an example, the individual data include vehicle information associated with the vehicle (e.g., type/model/year). In some embodiments, an initial list of drivers that will operate the vehicle is received from the user. In certain embodiments, the individual data related to the user are analyzed to determine a probability of accuracy for the initial list of drivers. For example, what is the probability that the user has disclosed all additional drivers that will operate the vehicle for purposes of insuring the vehicle.

According to certain embodiments, analyzing the individual data includes analyzing claims data from insurance policies of other users who share similar characteristics and/or vehicle information as the user. For example, the claims data are analyzed to determine which individuals submitted claims (e.g., submitted by insured drivers listed on the insurance policies of the other users or by someone else not listed on the insurance policies of the other users). As an example, a probability of whether the user has accurately disclosed additional drivers can be determined based at least in part upon analyzing the claims data. For example, a base rating factor is calculated based at least in part upon whether the user has accurately disclosed the additional drivers. As an example, the base rating factor is modified by the probability of whether the user has accurately disclosed the additional drivers. For example, the modified rating factor can be used to adjust a premium associated with the insurance quote requested by the user.

In various embodiments, the user initially disclosed drivers A and B as additional drivers. In some embodiments, analysis of the claims data may indicate that there is a 70% probability that another driver besides drivers A and B should have been disclosed. For example, if, after further inquiry, the user insists on only drivers A and B, then a base rating factor of 30% may be calculated because it is determined that the user is not being accurate in disclosing the additional drivers. As an example, the base rating factor is modified by the 70% probability that another driver should have been disclosed. For example, the premium will be adjusted by adding the modified rating factor to compensate for insurance coverage on undisclosed drivers that may be operating the vehicle. In certain embodiments, analysis of the claims data may indicate that only drivers A and B need to be disclosed. For example, if, after further inquiry, the user confirms only drivers A and B, then no rating factor needs to be calculated. As an example, the premium does not need to be adjusted since all drivers that will operate the vehicle will have been included in the insurance coverage.

According to certain embodiments, a system and/or a method for predicting a number of additional drivers in a household includes receiving a request for an insurance quote on a vehicle associated with a user; receiving individual data and household data associated with the user; receiving a reported number of additional drivers from the user; analyzing the individual data and the household data to determine an estimated number of additional drivers; and/or adjusting an insurance premium based at least in part upon a difference between the estimated number of additional drivers and the reported number of additional drivers.

According to some embodiments, a system and/or a method for predicting a number of additional drivers in a household includes receiving a request for an insurance quote on a vehicle associated with a user. For example, the user initiates the request and provides information about him/herself and about his/her household. In various embodiments, individual data and household data associated with the user are received. For example, the individual data include the user's characteristics (e.g., age, gender, occupation, city/state of residence, hobbies, etc.). As an example, the individual data include vehicle information associated with the vehicle (e.g., type/model/year). For example, the household data include information about the user's household such as a number of people living in the household, age and gender of those people, occupations of those people, a number of vehicles in the household, etc. In some embodiments, the individual data and the household data associated with the user are analyzed to determine an estimated number of additional drivers that the user's household should have. In various embodiments, the estimated number of additional drivers is compared to a reported number of additional drivers disclosed by the user when completing the insurance quote.

According to certain embodiments, analyzing the individual data and the household data includes analyzing other household data associated with other users who share similar characteristics and/or vehicle information as the user. For example, the estimated number of additional drivers in the user's household can be determined based at least in part upon analyzing the other household data associated with other users. As an example, the other household data can be obtained from various public databases (e.g., vital records). In certain embodiments, a rating factor is calculated based at least in part upon a difference between the estimated number of additional drivers and the reported number of additional drivers in the user's household. For example, the rating factor can be used to adjust a premium associated with the insurance quote requested by the user.

In various embodiments, the user indicates the reported number of additional drivers to be 3. In some embodiments, analysis of the individual data and the household data associated with the user may determine the estimated number of additional drivers to be 4. For example, the difference between the estimated number of additional drivers and the reported number of additional drivers is +1. As an example, the rating factor may be calculated to be 20% because it is determined that the user has underreported the number of additional drivers by one. For example, the premium will be adjusted by adding the rating factor to compensate for insurance coverage on unreported drivers in the household that may be operating the vehicle. In certain embodiments, analysis of the individual data and the household data associated with the user may determine the estimated number of additional drivers to be 2. For example, the difference between the estimated number of additional drivers and the reported number of additional drivers is −1. As an example, the rating factor may be calculated to be −20% because it is determined that the user has overreported the number of additional drivers by one. For example, the premium will be adjusted by subtracting the rating factor to better align insurance coverage on the actual drivers in the household that will be operating the vehicle.

In some embodiments, if the difference between the estimated number of additional drivers and the reported number of additional drivers is positive (e.g., user underreported additional drivers), the calculated rating factor is positive. In certain embodiments, if difference between the estimated number of additional drivers and the reported number of additional drivers is negative (e.g., user overreported additional drivers), the calculated rating factor is negative.

According to certain embodiments, a system and/or a method for predicting one or more probabilities corresponding to one or more numbers of additional drivers in a household includes receiving a request for an insurance quote on a vehicle associated with a user; receiving individual data and household data associated with the user; receiving a reported number of additional drivers from the user; analyzing the individual data and the household data to determine one or more probabilities corresponding to one or more estimated numbers of additional drivers; and/or adjusting an insurance premium based at least in part upon the one or more probabilities corresponding to the one or more estimated numbers of additional drivers in relation to the reported number of additional drivers.

According to some embodiments, a system and/or a method for predicting one or more probabilities corresponding to one or more numbers of additional drivers in a household includes receiving a request for an insurance quote on a vehicle associated with a user. For example, the user initiates the request and provides information about him/herself and about his/her household. In various embodiments, individual data and household data associated with the user are received. For example, the individual data include the user's characteristics (e.g., age, gender, occupation, city/state of residence, hobbies, etc.). As an example, the individual data include vehicle information associated with the vehicle (e.g., type/model/year). For example, the household data include information about the user's household such as a number of people living in the household, age and gender of those people, occupations of those people, a number of vehicles in the household, etc. In certain embodiments, the individual data and the household data associated with the user are analyzed to determine one or more probabilities corresponding to one or more estimated numbers of additional drivers that the user's household should have. In some embodiments, the one or more probabilities corresponding to the one or more estimated numbers of additional drivers are analyzed in view of one or more reported numbers of additional drivers disclosed by the user when completing the insurance quote.

According to certain embodiments, analyzing the individual data and the household data includes analyzing other household data associated with other users who share similar characteristics and/or vehicle information as the user. For example, the one or more probabilities corresponding to the one or more estimated numbers of additional drivers in the user's household can be determined based at least in part upon analyzing the other household data associated with other users. In some embodiments, a rating factor is calculated based at least in part upon the one or more probabilities corresponding to the one or more estimated numbers of additional drivers in relation to the one or more reported numbers of additional drivers in the user's household. For example, the rating factor can be used to adjust a premium associated with the insurance quote requested by the user.

In various embodiments, the user indicates a reported number of additional drivers to be 3. In some embodiments, analysis of the individual data and the household data associated with the user may determine a probability of the estimated number of additional drivers to be 2 is 10%, a probability of the estimated number of additional drivers to be 3 is 25%, and a probability of the estimated number of additional drivers to be 4 is 50%. For example, based at least in part upon the probabilities, it is highly likely that the user has underreported the number of additional drivers because there is a 50% chance that the estimated number of additional drivers is more than 3. As an example, the rating factor may be calculated to be 20% because of the likelihood that the user has underreported the number of additional drivers by one. For example, the premium will be adjusted by adding the rating factor to compensate for insurance coverage on unreported drivers in the household that may be operating the vehicle.

According to certain embodiments, a system and/or a method for determining which additional drivers in a household should be included to adjust insurance premium includes receiving a request for an insurance quote on a vehicle associated with a user; receiving individual data and household data associated with the user; analyzing the individual data and the household data to determine which members of the user's household should be included as additional drivers; and/or adjusting an insurance premium based at least in part upon which members of the user's household should be included as the additional drivers.

According to some embodiments, a system and/or a method for determining which additional drivers in a household should be included to adjust insurance premium includes receiving a request for an insurance quote on a vehicle associated with a user. For example, the user initiates the request and provides information about him/herself and about his/her household. In various embodiments, individual data and household data associated with the user are received. For example, the individual data include the user's characteristics (e.g., age, gender, occupation, city/state of residence, hobbies, etc.). As an example, the individual data include vehicle information associated with the vehicle (e.g., type/model/year). For example, the household data include characteristics of members of the user's household besides the user (e.g., age, gender, occupation, etc.). In various embodiments, the individual data and the household data associated with the user are analyzed to determine which members of the user's household should be included as additional drivers.

According to certain embodiments, analyzing the individual data and the household data includes analyzing insurance policy data of other users who share similar individual characteristics, vehicle information, and/or household member characteristics as the user. For example, the insurance policy data of the other users are analyzed to determine how each member of the user's household is similar or dissimilar to other individuals in the households of the other users. As an example, which members of the user's household should be included as additional drivers can be determined based at least in part upon analyzing the insurance policy data of the other users. In some embodiments, the user is reminded to add those members of the user's household that have been determined as the additional drivers. In certain embodiments, those members of the user's household that have been determined as the additional drivers are automatically included. In some embodiments, a rating factor is calculated for each member of the user's household that should be included as an additional driver. For example, the rating factor can be used to adjust a premium associated with the insurance quote requested by the user.

In various embodiments, the user lists individuals A and B as drivers of the vehicle. In some embodiments, analysis of the individual data and the household data may determine that another individual C resides in the user's household and that individual C is 100% likely to be an additional driver. For example, the rating factor may be calculated to be 20% for individual C. As an example, the premium will be adjusted by adding the rating factor to compensate for insurance coverage on individual C who is highly likely to be operating the vehicle.

According to certain embodiments, a system and/or a method for determining one or more probabilities that one or more additional drivers in a household should be included to adjust insurance premium includes receiving a request for an insurance quote on a vehicle associated with a user; receiving individual data and household data associated with the user; analyzing the individual data and the household data to determine one or more probabilities that one or more members of the user's household should be included as one or more additional drivers; and/or adjusting an insurance premium based at least in part upon the one or more probabilities that one or more members of the user's household should be included as one or more additional drivers.

According to some embodiments, a system and/or a method for determining one or more probabilities that one or more additional drivers in a household should be included to adjust insurance premium includes receiving a request for an insurance quote on a vehicle associated with a user. For example, the user initiates the request and provides information about him/herself and about his/her household. In various embodiments, individual data and household data associated with the user are received. For example, the individual data include the user's characteristics (e.g., age, gender, occupation, city/state of residence, hobbies, etc.). As an example, the individual data include vehicle information associated with the vehicle (e.g., type/model/year). For example, the household data include characteristics of members of the user's household besides the user (e.g., age, gender, occupation, etc.). In various embodiments, the individual data and the household data associated with the user are analyzed to determine one or more probabilities that one or more members of the user's household should be included as additional drivers.

According to certain embodiments, analyzing the individual data and the household data includes analyzing insurance policy data of other users who share similar individual characteristics, vehicle information, and/or household member characteristics as the user. For example, the insurance policy data of the other users are analyzed to determine how each member of the user's household is similar or dissimilar to other individuals in the households of the other users. As an example, the one or more probabilities that the one or more members of the user's household should be included as additional drivers can be determined based at least in part upon analyzing the insurance policy data of the other users. In some embodiments, a rating factor is calculated based at least in part upon the one or more probabilities that each member of the user's household being included as an additional driver. For example, the rating factor can be used to adjust a premium associated with the insurance quote requested by the user.

In various embodiments, the user lists individuals A and B as drivers of the vehicle. In some embodiments, analysis of the individual data and the household data may determine that another individual C who resides in the user's household has a 50% probability of being included as an additional driver. For example, the rating factor may be calculated for individual C and modified by the 50% probability. As an example, the premium will be adjusted by adding the rating factor to compensate for insurance coverage on individual C who is likely to be operating the vehicle.

According to certain embodiments, a system and/or a method for determining which additional drivers in a household should be excluded from insurance coverage based at least in part upon a determined list of additional drivers includes receiving a request for an insurance quote on a vehicle associated with a user; receiving individual data and household data associated with the user; analyzing the individual data and the household data to determine which members of the user's household should be included as additional drivers; and/or determining which members of the user's household should be excluded from insurance coverage based at least in part upon which members of the user's household should be included as additional drivers.

According to some embodiments, a system and/or a method for determining which additional drivers in a household should be excluded from insurance coverage based at least in part upon a determined list of additional drivers includes receiving a request for an insurance quote on a vehicle associated with a user. For example, the user initiates the request and provides information about him/herself and about his/her household. In various embodiments, individual data and household data associated with the user are received. For example, the individual data include the user's characteristics (e.g., age, gender, occupation, city/state of residence, hobbies, etc.). As an example, the individual data include vehicle information associated with the vehicle (e.g., type/model/year). For example, the household data include characteristics of members of the user's household besides the user (e.g., age, gender, occupation, etc.). In various embodiments, the individual data and the household data associated with the user are analyzed to determine which members of the user's household should be included as additional drivers and/or determining which members of the user's household should be excluded from insurance coverage.

According to certain embodiments, analyzing the individual data and the household data includes analyzing insurance policy data of other users who share similar individual characteristics, vehicle information, and/or household member characteristics as the user. For example, the insurance policy data of the other users are analyzed to determine how each member of the user's household is similar or dissimilar to other individuals in the households of the other users. As an example, which members of the user's household should be included as additional drivers can be determined based at least in part upon analyzing the insurance policy data of the other users. For example, which members of the user's household should be excluded from insurance coverage can be determined based at least in part upon which members of the user's household should be included as additional drivers.

According to some embodiments, a system and/or a method for determining which additional drivers in a household should be excluded from insurance coverage based at least in part upon one or more probabilities for one or more members of the household includes receiving a request for an insurance quote on a vehicle associated with a user; receiving individual data and household data associated with the user; analyzing the individual data and the household data to determine one or more probabilities that one or more members of the user's household should be included as one or more additional drivers, and/or determining which members of the user's household should be excluded from insurance coverage based at least in part upon the one or more probabilities that one or more members of the user's household should be included as one or more additional drivers.

According to certain embodiments, a system and/or a method for determining which additional drivers in a household should be excluded from insurance coverage based at least in part upon one or more probabilities for one or more members of the household includes receiving a request for an insurance quote on a vehicle associated with a user. For example, the user initiates the request and provides information about him/herself and about his/her household. In various embodiments, individual data and household data associated with the user are received. For example, the individual data include the user's characteristics (e.g., age, gender, occupation, city/state of residence, hobbies, etc.). As an example, the individual data include vehicle information associated with the vehicle (e.g., type/model/year). For example, the household data include characteristics of members of the user's household besides the user (e.g., age, gender, occupation, etc.). In some embodiments, the individual data and the household data associated with the user are analyzed to determine one or more probabilities that one or more members of the user's household should be included as additional drivers and/or determining which members of the user's household should be excluded from insurance coverage.

According to some embodiments, analyzing the individual data and the household data includes analyzing insurance policy data of other users who share similar individual characteristics, vehicle information, and/or household member characteristics as the user. For example, the insurance policy data of the other users are analyzed to determine how each member of the user's household is similar or dissimilar to other individuals in the households of the other users. As an example, the one or more probabilities that the one or more members of the user's household should be included as additional drivers can be determined based at least in part upon analyzing the insurance policy data of the other users. For example, which members of the user's household should be excluded from insurance coverage can be determined based at least in part upon the one or more probabilities that the one or more members of the user's household should be included as additional drivers. VI. EXAMPLES OF MACHINE LEARNING ACCORDING TO CERTAIN

### Embodiments

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images, object statistics and information, historical estimates, and/or actual repair costs. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

### VII. Additional Considerations According to Certain Embodiments

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, while the embodiments described above refer to particular features, the scope of the present disclosure also includes embodiments having different combinations of features and embodiments that do not include all of the described features. As an example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

1. A computer-implemented method for determining which members of a user's household should be included as additional drivers on the user's insurance policy, the method comprising:
collecting a set of training data associated with one or more users from a database, the set of training data including individual and household data and insurance data of one or more users;
applying one or more analysis to the set of training data to determine one or more features associated with predicting whether one or more members of a household of a user of the one or more users should be covered as one or more additional drivers by an insurance policy of the user of the one or more users;
training a machine learning model using the set of training data and the one or more features;
receiving first individual and household data associated with a first user;
determining one or more first characteristics of the first user based at least in part upon the first individual and household data;
retrieving second individual and household data associated with multiple second users, each second user of the multiple second users possessing respective one or more second characteristics;
for each second user of the multiple second users:
analyzing the respective one or more second characteristics;
determining one or more differences between the respective one or more second characteristics and the one or more first characteristics to determine whether the one or more differences satisfy one or more predetermined conditions;
if the one or more differences are determined to satisfy the one or more predetermined conditions, selecting each second user of the multiple second users having one or more differences that satisfied the one or more predetermined conditions as a third user to be included in one or more third users;
retrieving insurance data of the one or more third users from the database;
determining, using the machine learning model, one or more probabilities that one or more members of the first user's household should be included as one or more additional drivers based at least in part upon the insurance data of the one or more third users;
generating an insurance quote on a vehicle associated with the first user based at least in part upon the one or more probabilities that the one or more members of the first user's household should be included as the one or more additional drivers; and
displaying the insurance quote on the vehicle associated with the first user.

2. The computer-implemented method of claim 1, wherein the determining, by the machine learning model, the one or more probabilities that the one or more members of the first user's household should be included as the one or more additional drivers includes:
processing third individual and household data and the insurance data of the one or more third users to generate the one or more probabilities that the one or more members of the first user's household should be included as the one or more additional drivers.

3. The computer-implemented method of claim 2, wherein the processing the third individual and household data and the insurance data of the one or more third users to generate the one or more probabilities includes:
providing the third individual and household data and the insurance data of the one or more third users to an artificial neural network to generate the one or more probabilities that the one or more members of the first user's household should be included as the one or more additional drivers.

4. The computer-implemented method of claim 3, wherein the providing the third individual and household data and the insurance data of the one or more third users to the artificial neural network includes:
training the artificial neural network based at least in part upon the third individual and household data and the insurance data of the one or more third users.

5. The computer-implemented method of claim 1, wherein the first individual and household data associated with the first user include personal and vehicle information associated with the first user.

6. The computer-implemented method of claim 5, wherein the first individual and household data associated with the first user include personal and vehicle information associated with the one or more members of the first user's household.

7. The computer-implemented method of claim 1, further comprising:
calculating respective rating factors for each member of the one or more members of the first user's household that should be included as the one or more additional drivers; and
generating the insurance quote on the vehicle associated with the first user based at least in part upon the respective rating factors.

8. A computing device for determining which members of a user's household should be included as additional drivers on the user's insurance policy, the computing device comprising:
one or more processors; and
a memory storing instructions that, when executed by the one or more processors, cause the one or more processors to:
collect a set of training data associated with one or more users from a database, the set of training data including individual and household data and insurance data of one or more users;
apply one or more analysis to the set of training data to determine one or more features associated with predicting whether one or more members of a household of a user of the one or more users should be covered as one or more additional drivers by an insurance policy of the user of the one or more users;
train a machine learning model using the set of training data and the one or more features;
receive first individual and household data associated with a first user;
determine one or more first characteristics of the first user based at least in part upon the first individual and household data;
retrieve second individual and household data associated with multiple second users, each second user of the multiple second users possessing respective one or more second characteristics;
for each second user of the multiple second users:
analyze the respective one or more second characteristics;
determine one or more differences between the respective one or more second characteristics and the one or more first characteristics to determine whether the one or more differences satisfy one or more predetermined conditions;
if the one or more differences are determined to satisfy the one or more predetermined conditions, select each second user of the multiple second users having one or more differences that satisfied the one or more predetermined conditions as a third user to be included in one or more third users;
retrieve insurance data of the one or more third users from the database;
determine, using the machine learning model, one or more probabilities that one or more members of the first user's household should be included as one or more additional drivers based at least in part upon the insurance data of the one or more third users;
generate an insurance quote on a vehicle associated with the first user based at least in part upon the one or more probabilities that the one or more members of the first user's household should be included as the one or more additional drivers; and
display the insurance quote on the vehicle associated with the first user.

9. The computing device of claim 8, wherein the instructions that cause the one or more processors to determine, by the machine learning model, the one or more probabilities that the one or more members of the first user's household should be included as the one or more additional drivers further comprise instructions that cause the one or more processors to:
process third individual and household data and the insurance data of the one or more third users to generate the one or more probabilities that the one or more members of the first user's household should be included as the one or more additional drivers.

10. The computing device of claim 9, wherein the instructions that cause the one or more processors to process the third individual and household data and the insurance data of the one or more third users to generate the one or more probabilities further comprise instructions that cause the one or more processors to:
provide the third individual and household data and the insurance data of the one or more third users to an artificial neural network to generate the one or more probabilities that the one or more members of the first user's household should be included as the one or more additional drivers.

11. The computing device of claim 10, wherein the instructions that cause the one or more processors to provide the third individual and household data and the insurance data of the one or more third users to the artificial neural network further comprise instructions that, when executed by the one or more processors, cause the one or more processors to train the artificial neural network based at least in part upon the third individual and household data and the insurance data of the one or more third users.

12. The computing device of claim 8, wherein the first individual and household data associated with the first user include personal and vehicle information associated with the first user.

13. The computing device of claim 12, wherein the first individual and household data associated with the first user include personal and vehicle information associated with the one or more members of the first user's household.

14. The computing device of claim 8, wherein the instructions further comprise instructions that, when executed by the one or more processors, cause the one or more processors to:
calculate respective rating factors for each member of the one or more members of the first user's household that should be included as the one or more additional drivers; and
generate the insurance quote on the vehicle associated with the first user based at least in part upon the respective rating factors.

15. A non-transitory computer-readable medium storing instructions for determining which members of a user's household should be included as additional drivers on the user's insurance policy, the instructions when executed by one or more processors of a computing device, cause the computing device to:
collect a set of training data associated with one or more users from a database, the set of training data including individual and household data and insurance data of one or more users;
apply one or more analysis to the set of training data to determine one or more features associated with predicting whether one or more members of a household of a user of the one or more users should be covered as one or more additional drivers by an insurance policy of the user of the one or more users;
train a machine learning model using the set of training data and the one or more features;
receive first individual and household data associated with a first user;
determine one or more first characteristics of the first user based at least in part upon the first individual and household data;
retrieve second individual and household data associated with multiple second users, each second user of the multiple second users possessing respective one or more second characteristics;
for each second user of the multiple second users:
analyze the respective one or more second characteristics;
determine one or more differences between the respective one or more second characteristics and the one or more first characteristics to determine whether the one or more differences satisfy one or more predetermined conditions;
if the one or more differences are determined to satisfy the one or more predetermined conditions, select each second user of the multiple second users having one or more differences that satisfied the one or more predetermined conditions as a third user to be included in one or more third users;
retrieve insurance data of the one or more third users from the database;
determine, using the machine learning model, one or more probabilities that one or more members of the first user's household should be included as one or more additional drivers based at least in part upon the insurance data of the one or more third users;
generate an insurance quote on a vehicle associated with the first user based at least in part upon the one or more probabilities that the one or more members of the first user's household should be included as the one or more additional drivers; and
display the insurance quote on the vehicle associated with the first user.

16. The non-transitory computer-readable medium of claim 15, wherein the instructions when executed by the one or more processors that cause the computing device to determine, by the machine learning model, the one or more probabilities that the one or more members of the first user's household should be included as the one or more additional drivers further cause the computing device to:
process third individual and household data and the insurance data of the one or more third users to generate the one or more probabilities that the one or more members of the first user's household should be included as the one or more additional drivers.

17. The non-transitory computer-readable medium of claim 16, wherein the instructions when executed by the one or more processors that cause the computing device to process the third individual and household data and the insurance data of the one or more third users to generate the one or more probabilities that the one or more members of the first user's household should be included as the one or more additional drivers further cause the computing device to:
provide the third individual and household data and the insurance data of the one or more third users to an artificial neural network to generate the one or more probabilities that the one or more members of the first user's household should be included as the one or more additional drivers.

18. The non-transitory computer-readable medium of claim 15, wherein the first individual and household data associated with the first user include personal and vehicle information associated with the first user.

19. The non-transitory computer-readable medium of claim 18, wherein the first individual and household data associated with the first user include personal and vehicle information associated with the one or more members of the first user's household.

20. The non-transitory computer-readable medium of claim 15, wherein the instructions, when executed by the one or more processors, further cause the computing device to:
calculate respective rating factors for each member of the one or more members of the first user's household that should be included as the one or more additional drivers; and generate the insurance quote on the vehicle associated with the first user based at least in part upon the respective rating factors.
